(19) United States
(12) Patent Application Publication
(10) Pub. No.: US 2026/0037149 A1
(43) Pub. Date: Feb. 5, 2026

(54) STORAGE SYSTEM

(71) Applicant: Hitachi Vantara, Ltd., Yokohama-shi (JP)

(72) Inventors: Hiroka IHARA, Tokyo (JP); Tomohiro YOSHIHARA, Tokyo (JP); Takashi NAGAO, Tokyo (JP); Masahiro TSURUYA, Tokyo (JP)

(73) Assignee: Hitachi Vantara, Ltd., Yokohama-shi (JP)

(21) Appl. No.: 19/074,622

(22) Filed: Mar. 10, 2025

(30) Foreign Application Priority Data
Jul. 30, 2024 (JP) 2024-123569

(51) Int. Cl. G06F 3/06

(52) U.S. Cl. CPC G06F 3/0619; G06F 3/0634; G06F 3/0644; G06F 3/067

(57) ABSTRACT

A storage controller provides a storage area of physical drives forming a distributed parity group as a pool to a host device. The pool is formed by one or more virtual parity groups including virtual drives. The state of each of the physical drives includes a first state in which an input or an output of data is enabled, and a second state in which an input and an output of data are disabled, and in which less power is consumed than that in the first state. The storage controller causes one or more physical drives deleted from the pool to transition from the first state to the second state, and adds the one or more physical drives in the second state to the pool after causing the one or more physical drives to transition to the first state.

### CLAIM OF PRIORITY

The present application claims priority from Japanese patent application JP 2024-123569 filed on Jul. 30, 2024, the content of which is hereby incorporated by reference into this application.

### BACKGROUND OF THE INVENTION

### 1. Field of the Invention

The present invention relates to power savings in storage systems.

### 2. Description of the Related Art

In recent years, with an increase in the environmental awareness in the IT industry, there are demands for reducing the power consumptions in servers and storage devices that are operated in data centers. In particular, in a storage device having large-capacity drives for mission critical applications, the power consumed by the drives takes up a large proportion of the power consumed in the entire storage device. Saving the power consumed by the drives is therefore critical in the power saving of the entire storage device. Examples of the drives herein include solid state drives (SSDs) and hard disk drives (HDDs).

Generally, storage devices having a thin-provisioning (capacity virtualization) function combine physical storage areas that are distributed across a plurality of drives, to provide a virtual storage area referred to as a thin-provisioned pool. Hereinafter, a virtual storage area provided by a storage device having the thin provisioning function will be simply referred to as a pool.

The data stored in a pool is distributed across the drives forming the pool. Furthermore, sometimes data protection using the redundant array of inexpensive disks (RAID) are set among the drives forming a pool.

Because pools are usually designed with an extra capacity, power savings of the drives can be achieved by allocating the data to some of the drives in a pool, and causing the drives no longer allocated with data to transition to a low-power consumption state. Hereinafter, such power control will be referred to as pool power control.

To implement the pool power control, the storage device is required to have a function of evacuating data from a drive in the pool, of excluding the drive from the management of the pool, and of causing the drive to transition to a low-power consumption state; and a function of causing the drive in the hibernation to exit the low-power consumption state, incorporating the drive into the management of the pool, and making the drive available for data allocation.

Hereinafter, the former function and an operation for implementing the former function will be referred to as drive hibernation, and the latter function and an operation for implementing the latter function will be referred to as drive resuming. In addition, a drive having been hibernated will be referred to as a drive in a hibernation state, and a drive not having been hibernated or having been resumed will be referred to as a drive in an active state.

Note that, in the pool power control, the drives do not need to be hibernated or resumed in units of one drive. For example, in a configuration in which data stored in the drives is protected by RAID, the drives may be hibernated or resumed simultaneously in units of a group of drives by which the data protection is implemented.

Note that JP 2010-33261 A discloses one type of pool power control. In the pool power control disclosed in JP 2010-33261 A, a part of the drives is hibernated upon detecting that a vacant capacity in the pool becomes equal to or greater than a threshold, or upon receiving an input of a command. The drive in the hibernation state is resumed upon detecting that the vacant capacity of the pool becomes equal to or less than the threshold.

### SUMMARY OF THE INVENTION

There is a demand for a pool power control method by which the power consumption of a storage device can be reduced effectively.

One aspect of the present invention provides a storage system including: a plurality of physical drives that physically store data; and a storage controller that controls an access to the plurality of physical drives, in which the plurality of physical drives form a distributed parity group, the storage controller is configured to provide storage areas of the plurality of physical drives forming the distributed parity group to a host device as a pool that is a virtual storage area, the pool includes one or more virtual parity groups including a plurality of virtual drives, number of the plurality of virtual drives forming the virtual parity group is equal to or smaller than number of physical drives forming the distributed parity group, each of the plurality of physical drives has a first state in which an input or an output of data is enabled; and a second state in which an input and an output of data are disabled, and less power is consumed than power consumed in the first state, and the storage controller is configured to: cause one or more physical drives having been deleted from the pool to transition from the first state to the second state; and add the one or more physical drives to the pool after causing the one or more physical drives in the second state to transition to the first state.

One aspect of the present invention provides a storage system including: a plurality of physical drives; and a storage controller that controls an access to the plurality of physical drives, wherein the plurality of physical drives form a plurality of parity groups, the storage controller is configured to provide storage areas of the plurality of parity groups to a host device as a pool that is a virtual storage area, and each of the plurality of physical drives has a first state in which an input or an output of data is enabled; and a second state in which an input and an output of data are disabled, and less power is consumed than power consumed in the first state, and the storage controller is configured: to cause a first parity group deleted from the pool to transition from the first state to the second state; and to identify a component a type of which is different from a physical drive and that is capable of being transitioned from a normal state to a low-power consumption state by causing the first parity group to transition to the second state, to cause the component transition to the low-power consumption state, to add the first parity group to the pool after causing the first parity group to transition from the second state to the first state, and to cause the component to transition to the normal state.

According to the exemplary embodiment of the present invention, it is possible to control the power consumption of the storage device, effectively. Problems, configurations, and advantageous effects other than those explained above will become clear in the following description of the embodiment.

### BRIEF DESCRIPTION OF THE DRAWINGS

FIG. 1 illustrates a configuration example of a storage device according to first, second, and third embodiments;

FIG. 2 illustrates a configuration example of a parity group formed in the distributed RAID system in the first embodiment;

FIG. 3 illustrates a configuration example of parcel mapping according to the first embodiment;

FIGS. 4A and 4B illustrate a configuration example of a cycle according to the first embodiment;

FIG. 5 illustrates an example of a process of expanding a distributed parity group in units of one drive in the first embodiment;

FIG. 6 illustrates an example of a process of expanding a distributed parity group with drives of a RAID width, according to the first embodiment;

FIG. 7 is a configuration example of pool power control using a distributed RAID system according to the first embodiment;

FIG. 8 illustrates an example of a state transition of a pool according to the first embodiment;

FIG. 9 is a configuration example of a pool power control setting screen according to the first embodiment;

FIG. 10 illustrates an operation example of the pool power control according to the first embodiment;

FIG. 11 illustrates an example of the pool power control implemented with a distributed RAID according to a second embodiment;

FIG. 12 illustrates an example of a state transition of a pool according to the second embodiment;

FIG. 13 illustrates a configuration example of a cycle management table according to the second embodiment;

FIG. 14 illustrates an example of rewritable data storage logic according to the second embodiment;

FIG. 15 is a flowchart of a drive hibernating process according to the second embodiment;

FIG. 16 is a flowchart of a drive resuming process according to the second embodiment;

FIG. 17 illustrates an example of pool power control implemented with a conventional RAID in a third embodiment;

FIG. 18 illustrates an example of a state transition of a pool according to the third embodiment; and

FIG. 19 is a configuration example of a pool power control setting screen according to the third embodiment.

### DESCRIPTION OF THE PREFERRED EMBODIMENTS

Some embodiments will now be explained with reference to drawings. To begin with, matters preconditioning the subsequent description will be described.

First, the embodiments described below are not intended to limit the scope of the present invention according to the claims, and not all of the combinations of the elements described in the embodiments are necessarily essential as a solution according to the present invention.

Second, in the following description, although a method for storing data or control information may be explained using data structures such as a table and a list, it is also possible to use a different data structure enabled for a representation equivalent thereto. Further, in the following description, in order to distinguish the items stored in a data structure such as a table or a list, integer IDs are sometimes assigned to respective items. However, these IDs may take any other ID format having uniqueness. Examples of the other ID formats include Globally Unique IDs (GUIDs) and character strings.

Third, in the following description, processing may be described using “program” as a subject of a sentence, but the program is interpreted and executed by a central processing unit (CPU), and the CPU controls components such as a memory and a port as necessary to execute processing described in the program. In addition, the CPU may execute the processing described in the program using an appropriate hardware accelerator, instead of executing the processing by itself, depending on the specific processing. Examples of the hardware accelerator include a compression accelerator that compresses and decompresses data on behalf of the CPU, and a DMA engine that performs data communication on behalf of the CPU.

Fourth, in the following description, an operation of a physical component and an operation performed on a logical data structure may be described without distinguishing one from the other; however, an operation on a logical data structure is executed by an operation of a physical component abstracted by the data structure, and an operation of a physical component is accompanied by an appropriate operation on a logical data structure abstracting the component. For example, when the storage controller makes a data input or output to and from a drive, the storage controller not only transmits or receives the data to or from the drive, but also updates a control information area of a memory or metadata sitting on a nonvolatile memory, so that a change in the state resultant of the data input or the data output is appropriately reflected to the logical data structures such as the thin-provisioned pool, which is an abstraction of the drives, or a parity group to which the drive belongs.

### First Embodiment

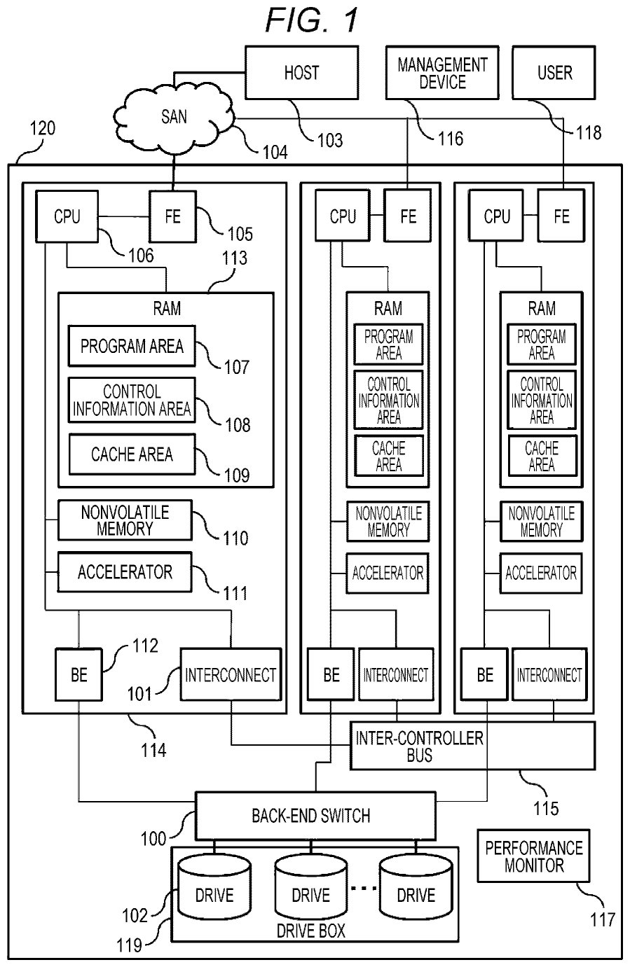

FIG. 1 illustrates a configuration example of a storage device according to this embodiment.

The storage device 120 includes one or more storage controllers 114 and one or more drives 102. The one or more storage controllers 114 are connected to a host 103 via one or more front-end ports 105, and can receive various commands from the host 103 and transmit and receive data to and from the host 103. The one or more storage controllers 114 are connected to the one or more drives 102 via one or more back-end ports 112, and can issue various commands to the one or more drives 102 and transmit and receive data to and from the one or more drives 102.

The host 103 is an information processing apparatus whose main function is to execute application programs. Examples of the host 103 include a mainframe and a server.

Each of the drives 102 is a nonvolatile storage device. Examples of the drive 102 include a solid state drive (SSD) and a hard disk drive (HDD). The drive 102 may be a built-in drive in the storage controller 114, or may be housed in a drive box 119 that is independent from the storage controller 114.

In this embodiment, the drive 102 has a normal state in which data input or output to or from the controller 114 is enabled, and a low-power consumption state in which data input and output are disabled and power consumption is low. It is possible for the drive 102 to have a low-power consumption state in which data input or output is enabled with a lower power consumption, or not to have the low-power consumption state but to achieve a low-power consumption state by stopping the power supply to the drive 102, using an external circuit that supplies power to the drive 102. The state in which the drive 102 is not receiving any power supply is one example of the low-power consumption state of the drive 102.

The storage controller 114 does not need to be connected to the host 103 and to the drives 102 directly, and only needs to have logical communication paths through which commands or data can be exchanged therewith.

One example of the connection between the storage controller 114 and the host 103 is via a storage area network (SAN) 104.

One example of the connection between the storage controller 114 and the drive 102 is via a back-end switch 100 that is capable of connecting a large number of NVMe drives to a single PCIe port. Hereinafter, components including the back-end switch 100, the drive box 119, and the back-end port 112 that are required for the CPU 106 to access a drive 102 will be referred to as upstream components.

Furthermore, as to the connections between the storage controllers 114 and the host 103, and the storage controllers 114 and the drives 102, it is not necessary for a logical communication path to be ensured between each one of the storage controllers 114 and the host 103, and each of the storage controllers 114 and each of the drives 102. Each of the storage controllers 114 may be provided with logical communication paths ensured with respect to only a part of the hosts 103 and a part of the drives 102.

The storage controllers 114 are connected to one another via an inter-controller bus 115, and can exchange commands and data via the inter-controller bus 115. Each of the storage controllers 114 can exchange a command and data with a host 103 or a drive 102 with which the storage controller 114 does not have a logical communication path, indirectly, by exchanging the command or the data with such a host 103 or drive 102 via the inter-controller bus 115.

In the following description related to an exchange of a command or data between the host 103, the storage controllers 114, and the drives 102, it is assumed that the command or the data is transmitted or received indirectly by causing each of the storage controllers 114 to exchange the command or the data with another storage controller 114 via the inter-controller bus 115, as required.

Upon receiving a read command from the host 103, the storage controller 114 reads the data stored in the drive 102 and transfers the read data to the host 103. Upon receiving a write command from the host 103, the storage controller 114 stores the data received from the host 103 in the drive 102.

The storage controller 114 includes a CPU 106 and a memory 113, and the CPU 106 has a function of executing a control program allocated in a program area 107 on the memory 113. The CPU 106 uses a cache area 109 on the memory 113 as a temporary data storage area, and uses a control information area 108 on the memory 113 as a control information storage area.

Note that the control program and the control information on the memory 113, and the data on the cache area 109 are non-volatilized, as necessary. The storage controller 114 may be provided with a nonvolatile memory 110 dedicated for non-volatilizing the control program and the control information on the memory 113 and the data on the cache area 109. Examples of the nonvolatile memory include a solid state drive (SSD) and a storage class memory (SCM).

The CPU 106 exchanges data or a command with the host 103 and the drive 102, in accordance with a description in the control program.

A management device 116 is built into the storage device 120 or connected to the storage device 120, and has a function of receiving an operation from a user 118 and a function of storing a setting performed by the user 118.

It is possible for the management device 116 not to be a piece of physical hardware, but to be management software that operates on a client PC connected to the storage device 120 over a network, for example.

In this embodiment, data on the drives 102 are protected by a distributed RAID system. The storage device 120 according to this embodiment has a function of saving the power consumption, achieved by the pool power control.

A distributed RAID system is a data protection system in which a parity group, which is formed by physical drives in a general RAID system (hereinafter, a conventional RAID), is replaced by a virtual parity group 200 formed by virtual drives, and the data in the virtual parity group is stored in a manner distributed across the physical drives. With a distributed RAID system, the number of physical drives can be determined independently from the RAID redundancy.

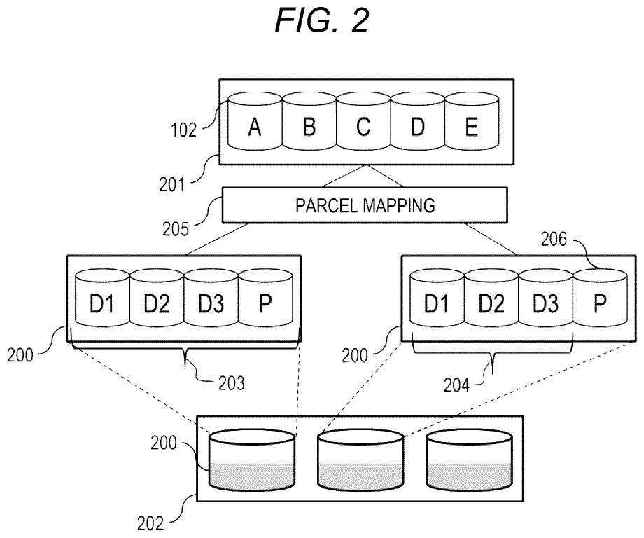

FIG. 2 illustrates a configuration example of a parity group formed in the distributed RAID system according to this embodiment.

In the distributed RAID system, virtual drives 203 form a virtual parity group 200, and a pool 202 is formed by combining virtual parity groups 200. A pool capacity is managed by using a virtual parity group 200 as the smallest unit. In other words, a pool capacity is extended by adding a virtual parity group 200 to the pool 202, and a pool capacity is shrunk by deleting a virtual parity group 200 from the pool 202.

The data stored in a virtual drive 203 is stored in a manner distributed across the physical drives 102, in a unit referred to as a parcel 300. A one-to-one correspondence that gives each parcel 300 in a virtual drive 203 a storage location in a physical drive 102 is referred to as parcel mapping 205.

In the explanation herein, a set of physical drives 102 across which the data of virtual parity groups 200 belonging to the same pool 202 is stored in a manner distributed will be referred to as a distributed parity group 201. The parcel mapping 205 is configured in such a manner that a virtual drive 203 in a virtual parity group 200 is given the location of a data storage in a physical drive 102 in a distributed parity group 201, and that the distributed parity group 201 has a redundancy at a level at least equivalent to or greater than that of the virtual parity group 200 corresponding thereto.

The redundancy of a virtual parity group 200 is expressed by partitioning the virtual drives 203 belonging to the virtual parity group into a virtual data drive 204 for storing data and a virtual parity drive 206.

In other words, a virtual parity group 200 including m virtual data drives 204 and n virtual parity drives 206 has the same redundancy as a parity group including m physical data drives and n physical parity drives. Hereinafter, the redundancy of the virtual parity group 200 will be expressed in the format of mDnP. For example, a virtual parity group with six virtual data drives and two virtual parity drives has a redundancy of 6D2P.

It is assumed herein that, when the number of physical drives 102 belonging to a distributed parity group (physical parity group) 201 is p, m+n≤p is established. It is also assumed herein that the physical drives 102 as a whole have a capacity capable of storing therein the entire parcels in all of the virtual drives 203.

Hereinafter, a configuration of the distributed parity group 201 including p virtual parity groups 200 each having mDnP redundancy will be expressed as mDnP×p.

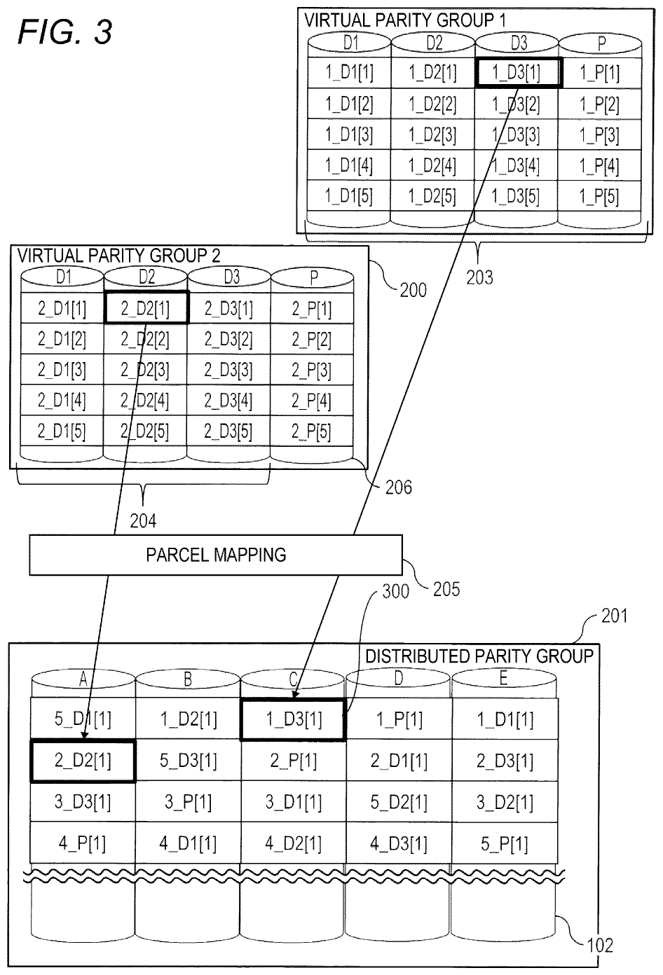

FIG. 3 illustrates a configuration example of the parcel mapping according to this embodiment.

The parcel mapping 205 gives each parcel 300 in a virtual drive 203 included in each of a plurality of virtual parity groups 200 mapped to a distributed parity group 201 a storage location in a physical drive 102 in the distributed parity group 201.

FIG. 3 illustrates a configuration example of the parcel mapping 205 between a distributed parity group 201 including five physical drives, and five virtual parity groups in a 3D1P configuration. However, only two of the five virtual parity groups 200 are illustrated for the purpose of saving the space.

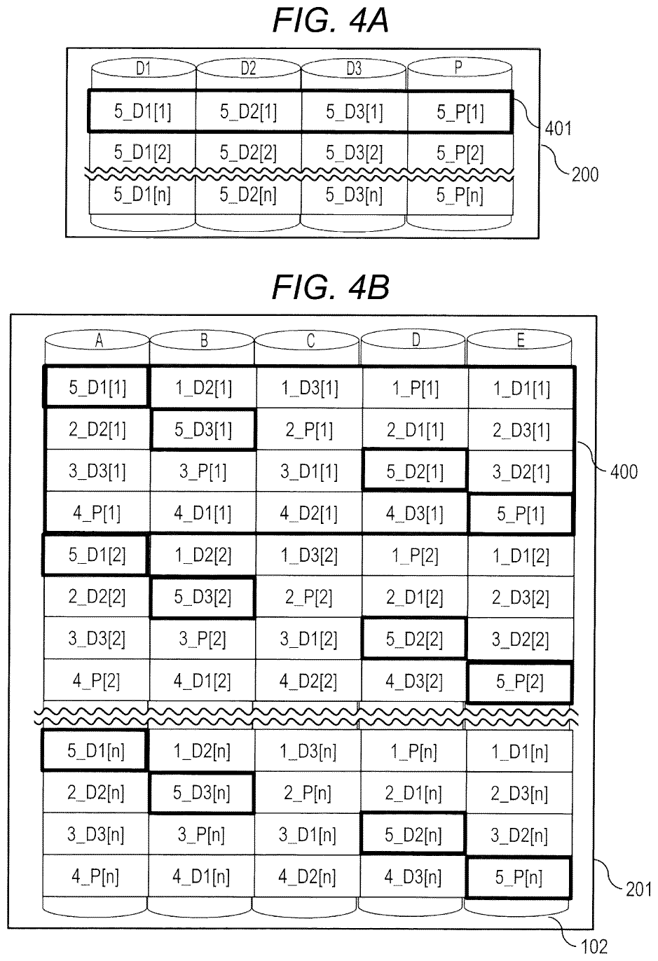

Hereinafter, a notation x_y [z] will be used as an expression for identifying an individual parcel 300. Where x is an ID for identifying a virtual parity group 200 belonging to the same distributed parity group 201 or the same pool 202. y is an ID of a virtual drive 203 belonging to the virtual parity group 200, and z is the location of a stripe 401 (see FIG. 4A) in the virtual drive 203. FIGS. 4A and 4B illustrate configuration examples of a stripe 401 and a cycle 400 according to this embodiment. A stripe 401 is a unit of data having a fixed length, to be stored in a virtual drive to which the RAID is applied.

Hereinafter, the value of x will be referred to as a virtual parity group ID; the value of y will be referred to as a virtual drive ID; and the value of z will be referred to as a stripe ID.

For example, the parcel 1_D1 [1] refers to a parcel 300 that belongs to a first virtual parity group 200, among the virtual parity groups 200 mapped with the same distributed parity group 201 or to the same pool 202, that belongs to a virtual drive D1, among the drives included in the first virtual parity group 200, and that belongs to a first stripe 401 among the stripes in the virtual drive 203.

The parcel mapping 205 is determined in such a manner that a redundancy requirement of the virtual parity group 200 is satisfied. For example, for a virtual parity group 200 with the redundancy of 6D2P, the parcels 300 belonging to the same stripe 401 are stored in different physical drives 102 so as to withstand simultaneous failures of two physical drives. This is referred to as a redundancy requirement.

It is also assumed that the parcel mapping 205 is repeated at a constant cycle. Hereinafter, the cycle at which the parcel mapping 205 is repeated will be referred to as a cycle 400. It is assumed herein that every parcel 300 in each cycle 400 on the virtual drive 203 is mapped to any one of the parcels 300 in the corresponding cycle on the physical drive 102, but not to those in the other cycles 400. It is also assumed that no plurality of parcels 300 on the virtual drive 203 is mapped to a single parcel 300 on the physical drive 102. In other words, parcel mapping 205 in a certain cycle 400 is bijective. This is referred to as a cyclicity requirement.

The parcel mapping 205 may be configured in any way, as long as the redundancy requirement and the cyclicity requirement are satisfied.

FIGS. 4A and 4B illustrate an example of the parcel mapping 205 from a virtual parity group 200 in a 3D1P configuration to a distributed parity group 201 in a 3D1P×5 configuration and including five physical drives. Note that only one of the five virtual parity groups 200 is illustrated and the rest is omitted, for the purpose of saving the space.

In the parcel mapping illustrated in FIGS. 4A and 4B, among the stripes in the five virtual parity groups 200 to be included in the distributed parity group 201, five stripes 401 with the same stripe ID are established as one cycle 400.

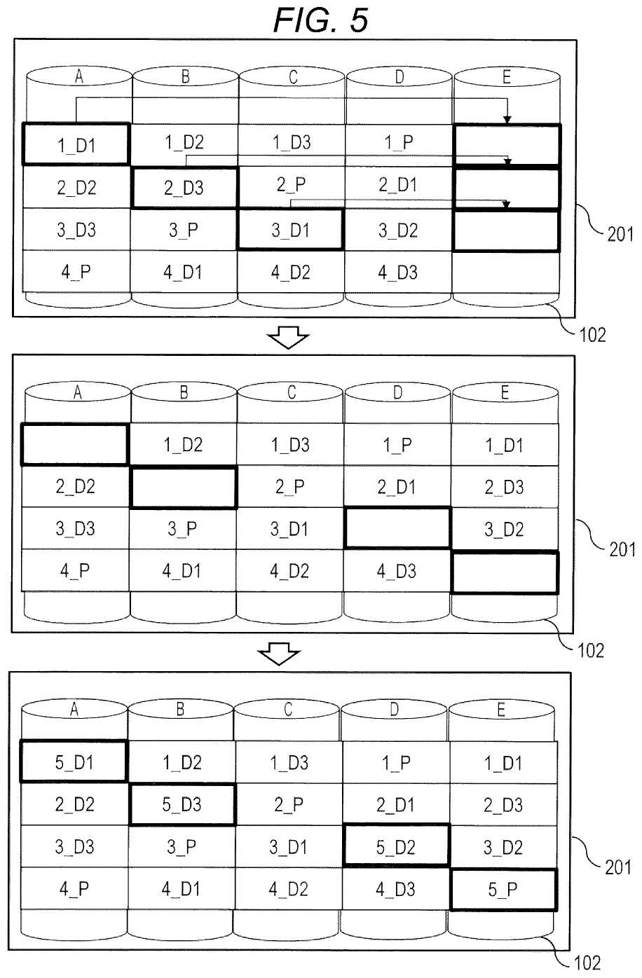

FIG. 5 illustrates an example of a process of expanding a distributed parity group in units of one drive in this embodiment.

FIG. 5 illustrates an example in which a distributed parity group 201 having a 3D1P×4 configuration is expanded to a 3D1P×5 configuration, by one physical drive. As mentioned earlier, in the distributed RAID system, the number of physical drives in the distributed parity group 201 is always matched with the number of virtual parity groups 200 in the distributed parity group 201. Therefore, it can be said that the example illustrated in FIG. 5 is an example in which the distributed parity group 201 having a 3D1P×4 configuration is expanded to a 3D1P×5 configuration by one virtual parity group.

However, in FIG. 5, only the process of expanding the distributed parity group 201 by a single cycle 400 is illustrated, and the process for the remaining cycles 400 is omitted, for the purpose of saving the space. The way in which the cycles 400 are configured follows the example illustrated in FIGS. 4A and 4B.

Hereinafter, expansion with a physical drive 102 in the distributed RAID system illustrated in FIG. 5 will be referred to as normal expansion.

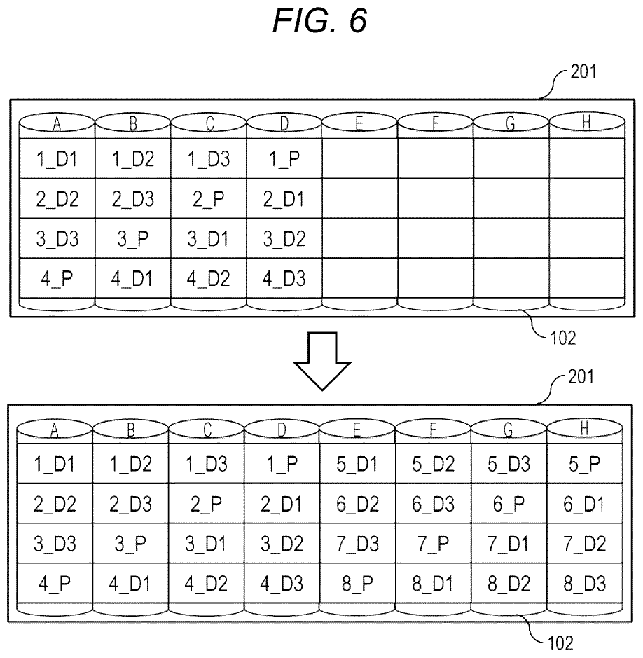

FIG. 6 illustrates an example of a process of expanding a distributed parity group with drives of a RAID width, according to this embodiment.

In the distributed RAID system, depending on the number of physical drives 102 by which the distributed parity group 201 is expanded at a time, the parcel mapping 205 can be changed without moving any existing data on the existing virtual parity groups 200. For example, in the example illustrated in FIG. 6, the four virtual parity groups of 3D1P, that is, the distributed parity group including four physical drives are extended by four virtual parity groups of 3D1P, which correspond to four physical drives.

At this time, it is possible to change the parcel mapping 205 without changing the locations of the parcels 300 on the existing four virtual parity groups 200, and to complete the expansion to drives without moving any data. Such an operation is referred to as immediate expansion. The immediate expansion is usually possible only when the number of physical drives 102 expanded at the same time is equal to the RAID width.

In the following description of the embodiment, immediate expansion and normal expansion are not distinguished from each other, assuming that immediate expansion is selected when the immediate expansion is possible, and normal expansion is selected when not, on the basis of the number of drives expanded at one time.

Because the process of removing the physical drives 102 from the distributed parity group 201 is reversal of the operations illustrated in FIGS. 5 and 6, a detailed description thereof will be omitted in this embodiment.

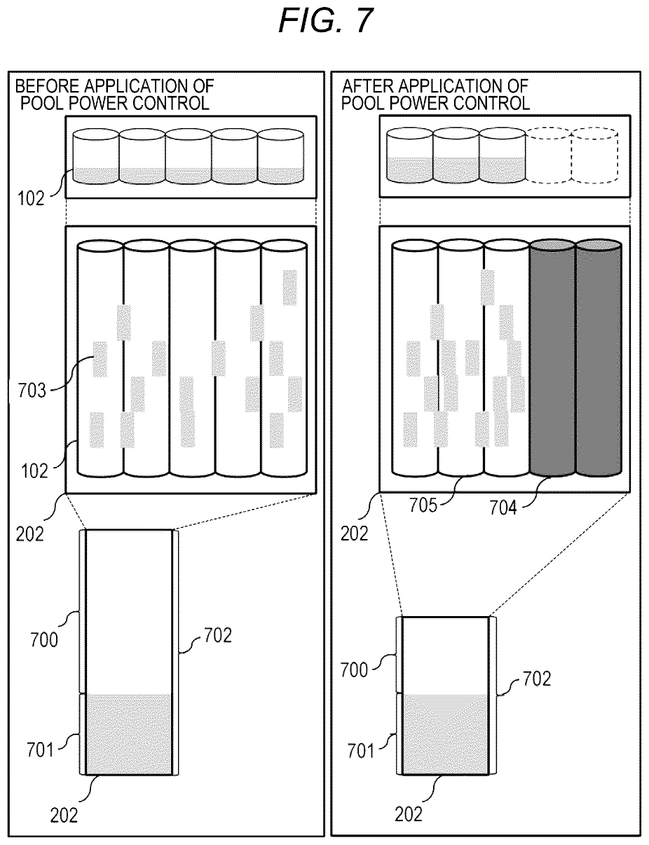

FIG. 7 illustrates a configuration example of the pool power control using the distributed RAID system according to this embodiment.

In a distributed RAID system, data 703 stored in a pool 202 is stored in a manner distributed across the physical drives 102 forming the pool 202. When the data is to be stored, a redundancy code (parity) is generated from the data 703 to be stored so that the data 703 is not lost even if some of the physical drives 102 fail. These parities are also stored in the physical drives 102 in a distributed manner, in the same manner as the data 703.

Examples of the method for generating the parities from the data 703 include RAID5 and RAID6.

To distribute the data 703 stored in the pool 202 across the drives 102, the logical storage area on the pool 202 is divided into parcels each having a fixed length, and parcel mapping for giving the location of a physical storage area on the physical drive 102 is created. On the basis of the parcel mapping, the data 703 stored in the pool 202 is distributed across the drives 102.

As a method for providing a storage area of the pool 202 to the host 103, for example, one or more logical volumes may be defined on the pool 202, and the logical volume may be provided to the host 103.

Management information pertinent to the utilization of the pool 202 as a storage area includes a total capacity 702 of the pool 202, a data capacity 701 stored in the pool 202, and a vacant capacity 700 in the pool 202.

As described earlier, in a distributed RAID system, with the use of virtual parity groups 200, physical drives 102 forming a pool 202 can be expanded or removed in units of one physical drive, without impairing the redundancy of the stored data 703.

In the pool power control based on the distributed RAID system, the power consumption of the physical drives 102 can be reduced by putting the physical drives 102 forming a pool 202 into a low-power consumption state (including stopping the power supply thereto), in units of one physical drive.

Note that, for a physical drive 102 forming a pool 202 to be transitioned to the low-power consumption state, it is not necessary to finish removing the physical drive 102 in the distributed RAID system, and the same applies to the reversal. The operation of removing a physical drive 102 in the distributed RAID system is an operation of evacuating the data 703 stored in the physical drive 102 to another physical drive 102 forming the same pool 202, of stopping the physical drive 102, and of releasing the mapping of the physical drive 102 to the pool 202. To put the physical drive 102 forming the pool 202 into the low-power consumption state, it is not necessary to release the mapping of the physical drive 102 to the pool 202, as long as the data 703 is evacuated and the physical drive 102 is stopped.

In this embodiment, operations of hibernation and activation of a physical drive 102 in the pool power control are clearly distinguished from the operations of removal and expansion in a distributed RAID system. In other words, in the operation of removing a drive 102 in the distributed RAID system, mapping between the deleted physical drives 102 and the pool 202 is released, so that another pool 202 can be expanded to the physical drive 102.

By contrast, in the “hibernating” operation according to this embodiment, data is evacuated from the physical drive 102 included in the pool 202, and then the physical drive 102 is excluded from the pool 202 and transitioned to the low-power consumption state. Such hibernated physical drives 102 are not accessed. The operation of “hibernating” a drive 102 according to this embodiment maintains, even during the hibernation state, the mapping between the hibernated physical drive 102 and the pool 202 to which the physical drive 102 has belonged before the physical drive 102 is put into hibernation. Therefore, it is assumed herein that a physical drive 102 in the hibernation state forming a pool A, for example, can neither be added to another pool B by the function of the pool power control, which will be described later, nor added to the pool B by a user operation, unless the physical drive 102 is removed from the pool A by a user operation.

In the “activating” operation, the low-power consumption state of the hibernated physical drive 102 is released, and the physical drive 102 is incorporated into the pool 202 so that the physical drive 102 is made available for data allocation. Note that drives in the hibernation state are those having been hibernated, and drives in the active state are those not having been hibernated or having been resumed.

In the following description, the terms “deletion/addition” may be used for drive operations that are different from “hibernation/activation” and “removal/expansion”. “Deleting” a physical drive 102 means an operation for evacuating the data 703 stored in the physical drive 102 to another physical drive 102, and putting the physical drive 102 into a state not recognized as a pool capacity, without transitioning the drive to the low-power consumption state. Deleting a physical drive 102 and then transitioning the physical drive 102 to the low-power consumption state are equivalent to hibernating physical drive. Stopping and deleting the physical drive 102, and then releasing the mapping between the physical drive 102 and the pool 202 are equivalent to removing the physical drive.

FIG. 7 illustrates an example in which two drives 102 are put into hibernation, in a pool 202 including five drives 102.

In the pool power control according to this embodiment, it is assumed that the timing at which a drive 102 is hibernated or resumed, and the number of drives to be hibernated or resumed are determined from two viewpoints of the vacant capacity 700 in the pool 202 and pool write performance. Note that the hibernation and resuming of a drive may be controlled on the basis of only one of the vacant capacity in the pool or the pool write performance.

In other words, if there is an extra vacant capacity 700 in the pool 202, some of the drives 102 are put into hibernation. If the vacant capacity 700 of the pool 202 falls short, the drives 102 having been put into hibernation is resumed so as to prevent exhaustion of the pool capacity. The drive is also put into hibernation when there is an allowance in the write performance of the drives forming the pool, with respect to the amount of writes to the pool 202, as requested by the host 103. Once the write performance becomes tight, the hibernated drive 102 is temporarily resumed even if there is an extra vacant capacity 700 in the pool, and the drives 102 are hibernated when the write performance come to have an allowance again.

Hereinafter, the pool power control that is based on the vacant capacity of the pool will be referred to as capacity-based pool power control, and the pool power control that is based on the pool performance will be referred to as performance-based pool power control.

An implementation example of the pool power control according to this embodiment will now be described.

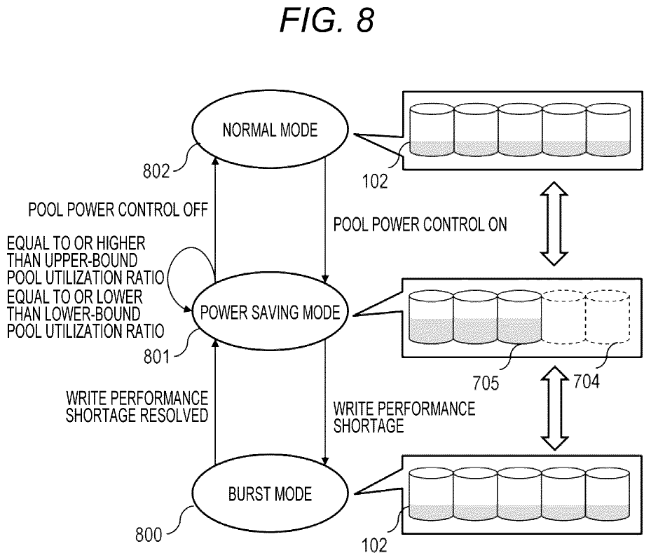

FIG. 8 illustrates an example of a state transition of a pool in this embodiment.

The pool 202 according to this embodiment has three modes of a normal mode 802, a power saving mode 801, and a burst mode 800.

The normal mode 802 is defined as a state in which the pool power control is disabled by setting. The power saving mode 801 is defined as a state in which the pool power control is enabled by setting, and some drives included in the pool has been hibernated. The burst mode 800 is defined as a state in which the pool power control is enabled by setting, but the drives 102 having been hibernated are temporarily resumed because of shortage in the write performance.

The transition between the normal mode 802 and the power saving mode 801 is triggered by the capacity-based pool power control, and the transition between the power saving mode 801 and the burst mode 800 is triggered by the performance-based pool power control.

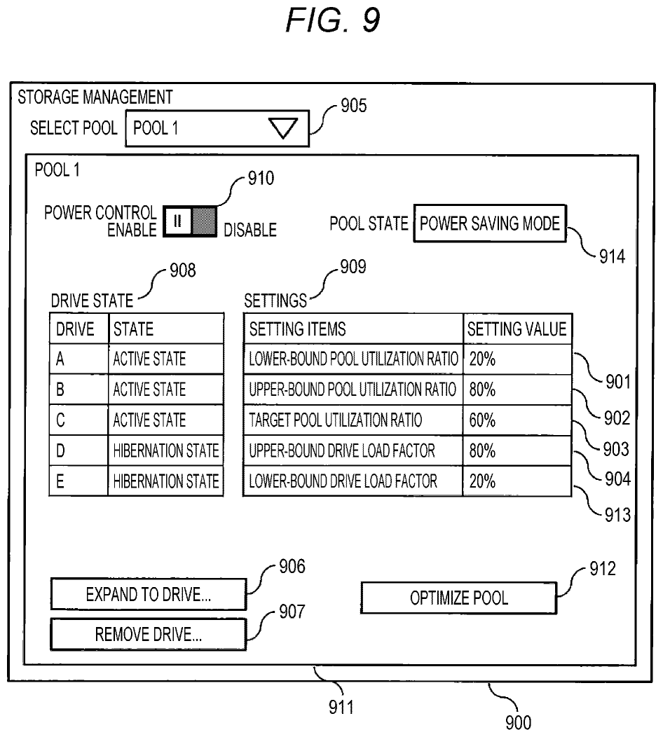

FIG. 9 illustrates a configuration example of a pool power control setting screen according to this embodiment.

When the user 118 selects one of the pools 202 in the storage device 120 from a pool list 905, a display 900 provided on the management device 116 displays a setting screen 911 for the pool 202.

The setting screen 911 for each pool 202 includes a switch 910 for enabling or disabling the pool power control for the pool, an indicator 914 for displaying the state of the pool, a drive state table 908 for displaying the states of the respective drives 102 included in the pool, and a power control parameter table 909 for setting pool power control parameters for the pool.

As to a function for selecting the drives 102 to be included in the pool 202, there is no particular limitation in this embodiment. It is assumed herein that there is an interface for allowing the user 118 to select a drive 102 to be included in the pool 202, from the drives 102 provided to the storage device 120. For example, the pool setting screen 911 may include a button 906 for expanding the pool with a drive, and a button 907 for removing a drive from the pool.

The drive state table 908 displays whether each drive 102 forming the pool 202 is in the active state or in the hibernation state.

The power control parameter table 909 is enabled to be specified with at least four parameters including a lower-bound pool utilization ratio 901, an upper-bound pool utilization ratio 902, a target pool utilization ratio 903, an upper-bound drive load factor 904, and a lower-bound drive load factor 913.

The pool setting screen 911 may also include a pool optimization button 912.

The power control switch 910 controls the transition between the normal mode 802 and the power saving mode 801. In other words, transition of the pool from the normal mode 802 to the power saving mode 801 is triggered by the power control switch 910 being switched from OFF to ON, and transition of the pool from the power saving mode 801 to the normal mode 802 is triggered by the power control switch 910 being switched from ON to OFF.

In the capacity-based pool power control, a trigger for hibernating the drive 102 and a trigger for resuming the drive 102 are determined by referring to the settings of the management device 116. It is also possible for such transitions to be triggered by only one of a user operation and a reference capacity.

For example, by being triggered by the pool utilization exceeding the upper-bound pool utilization ratio 902; the pool optimization button 912 being pressed by a user; or by the pool power control switch 910 being switched from ON to OFF by a user operation, the storage device 120 determines which drive to resume, when there is any drive in the hibernation state, using the target pool utilization ratio 903 as a reference, and resumes the drives.

It is assumed herein that the storage device 120 selects such a combination of drives to be resumed that the pool utilization ratio after resuming such drives becomes lower than the value set as the target pool utilization ratio 903, and that the number of drives to be resumed is minimized, from the drives in the hibernation state. In other words, assuming that the target pool utilization ratio 903 is set to UT [%]; the current pool utilization ratio is UC [%]; the total pool capacity is P [TB]; and the effective capacity per drive is C [TB], the number of drives-to-be-resumed NR is calculated by NR=CF((P×(UC−UT)/100)/C). Where CF (x) is an operator that returns the minimum integer equal to or greater than x.

Note that, because every drive included in the same pool need to have the same capacity, due to the restriction of the distributed RAID system, a drive having a capacity that is different from that of the drives having been already included in the pool is excluded from the selections of the drives to be resumed.

By contrast, by being triggered by the pool utilization falling below the lower-bound pool utilization ratio 901; by the pool optimization button 912 being pressed by the user; or by the pool power control switch 910 being switched from OFF to ON by a user operation, the storage controller 114 (CPU 106) determines the number of drives to be hibernated, using the target pool utilization ratio 903 as a reference, hibernates the drives, causes the pool to transition to the power saving mode 801.

It is assumed herein that the storage device 120 selects such a combination of drives to be hibernated that the pool utilization ratio after hibernating such drives becomes lower than the value set as the target pool utilization ratio 903, from the drives in the active state, and that the number of drives to be hibernated is minimized. In other words, assuming that the target pool utilization ratio 903 is set to UT [%]; the current pool utilization ratio is UC [%]; the total pool capacity is P [TB]; and the effective capacity per drive is C [TB], the number of drives-to-be-hibernated NS is calculated by NS=FF((P×(UT−UC)/100)/C). Where FF (x) is an operator that returns the maximum integer equal to or less than x.

Note that, because every drive included in the same pool has the same capacity, due to the restriction of the distributed RAID system, it is not necessary to consider the possibility that a drive with a different capacity is included in the pool.

In the performance-based pool power control, a trigger for hibernating the drive 102 and a trigger for resuming the drive 102 are determined by referring to an indication value of a performance monitor 117, as well as the settings in the management device 116. Note that the settings of the management device 116 may be omitted.

For example, the storage controller 114 monitors load factors of the respective drives 102 using the performance monitor 117 on the storage device 120. When the load factor of any drive, or a statistical value (e.g., average) of the load factors of all of the drives exceeds the upper-bound drive load factor 904, the storage controller 114 resumes all of the drives 704 in the hibernation state, if there is any drive 704 in the hibernation state in the pool, and causes the pool to transition to the burst mode 800. The load factor of one drive and the statistical value of the load factors of a plurality of drives are values that represent the drive load of the pool.

However, if the load factor of the CPU 106 is higher than a predetermined reference value (e.g., higher than a specified threshold) or the load factor of the front-end port 105 connecting the host 103 and the storage device 120 is higher than a predetermined reference value (e.g., higher than a specified threshold), for example, it is possible that the performance shortage is not resolved even by resuming the drives when the load factor of the drive 102 has exceeded the upper-bound drive load factor 904. The load factor of the CPU 106 may be, for example, the load factor of any one of the CPUs 106 that access the pool or a statistical value of the load factors of all of the CPUs 106 that access the pool. The same applies to the load factors of the front-end ports 105. These values are values representing the load of these respective components.

The storage device 120 may therefore be implemented to monitor the load factor of the components other than the drives, as well as the load of the drives, using the performance monitor 117, and to negate to resume the drives (does not resume the drives) and not to cause the pool to transition from the power saving mode, if it is determined that, although the value representing the drive load of the pool is high, the performance shortage is not improved even by resuming the drives, because the value representing the load of the other predetermined component is higher than a predetermined reference value.

Furthermore, the load factor of a drive is a parameter that changes greatly over time, that usually remains low but surges instantaneously. Hence, the performance monitor 117 may be configured to present an average of the load factors of the respective drives over a certain time period so that the pool power control is not released even when the load surges instantaneously, for example. The same applies to the load factor of other types of components, presented by the performance monitor 117.

The storage device 120 monitors the load factor of the drives 102 using the performance monitor 117. By being triggered by the drive load factor falling below the lower-bound drive load factor 913, the storage device 120 determines the number of drives to be hibernated on the basis of the target pool utilization ratio 903, hibernates the drives, and causes the pool to transition to the power saving mode 801.

It is assumed herein that the storage device 120 selects such a combination of drives to be hibernated that the pool utilization ratio after hibernating such drives becomes lower than the value set as the target pool utilization ratio 903, from the drives in the active state, and that the number of drives to be hibernated is minimized. In other words, assuming that the target pool utilization ratio 903 is set to UT [%]; the current pool utilization ratio is UC [%]; the total pool capacity is P [TB]; and the effective capacity per drive is C [TB], the number of drives-to-be-hibernated NS is calculated by NS=FF((P×(UT−UC)/100)/C). Where FF (x) is an operator that returns the maximum integer equal to or less than x.

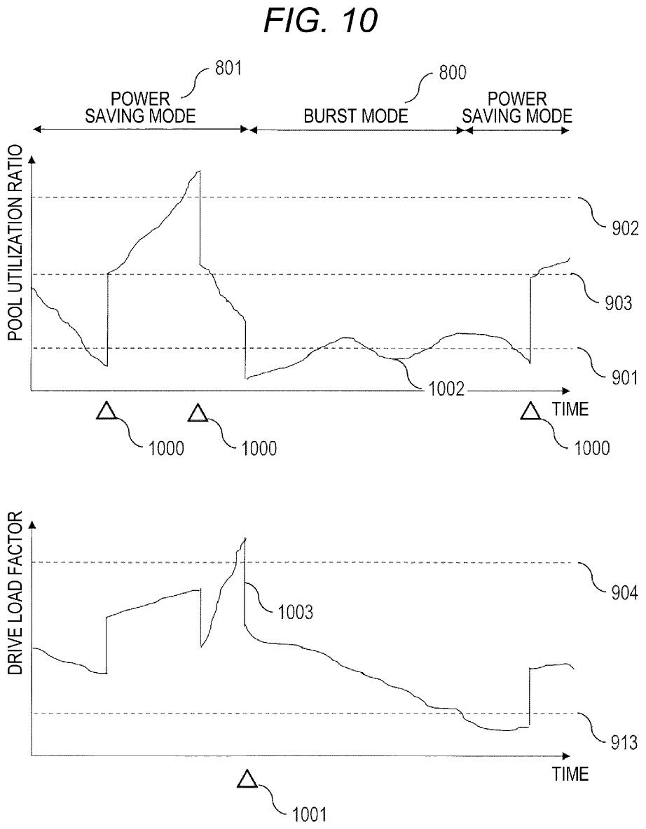

FIG. 10 illustrates an example of an operation of the pool power control according to this embodiment.

A capacity-based pool power control 1000 is configured to activate the drives 704 in the hibernation state while the pool 202 is in the power saving mode 801, by being triggered by the pool utilization ratio 1002 falling below the lower-bound pool utilization ratio 901, and to put the drives 705 in the active state into hibernation by being triggered by the pool utilization ratio 1002 exceeding the upper-bound pool utilization ratio 902.

By contrast, the performance-based pool power control 1001 is configured to activate all of the drives 704 in the hibernation state while the pool 202 is in the power saving mode, by being triggered by the drive load factor 1003 of any one of the drives or a statistical value of thereof of all of the drives exceeding the upper-bound drive load factor 904, and cause the pool 202 to transition to the burst mode. The burst mode 800 is not released until the drive load factors 1003 of all of the drives fall below the lower-bound drive load factor 913, and the capacity-based pool power control 1000 is inhibited during the burst mode 800.

The pool power control does not necessarily need to respond to an index such as the pool utilization ratio 1002 and the drive load factor 1003 immediately, and may be configured to, for example, check the index regularly, and hibernate the drive 102 if the index exhibits a deviation at the timing of the regular check. It is also possible for only one of the capacity-based pool power control and the performance-based pool power control to be implemented in the storage device.

As described above, the storage device provides a thin-provisioned pool that is a virtualized storage area of the drives redundantly configured with the RAID to the host device, and reduces the power consumption of the drives in the pool by excluding the drive from the pool and putting the drive into the low-power consumption state in units of one drive, by being triggered by a condition related to the vacant capacity in the pool or by a user operation.

### Second Embodiment

In a configuration in which the pool power control is implemented in units of one drive, with the use of the distributed RAID, as described in the first embodiment, there may be an issue in the movement of data at the time of resuming the drive.

In a distributed RAID, the data stored in a pool is distributed across the drives. The mapping between virtual storage areas in the pool and physical storage areas in the drives therefore changes as the drives are hibernated or resumed. As the mapping changes, the data the storage location which has changed in the drives is moved to a new storage area.

Because such movement of the data involved in resuming the drive 102 in the hibernation state may cause an increase in the drive load, even if the performance-based pool power control causes the pool 202 to transition to the burst mode 800 and causes the drive 102 in the hibernation state to resume upon detecting an increase in the drive load factor, the write performance having already deteriorated may become even worse.

For example, in a storage device for mission critical applications, any adverse effect given to the operations of the applications by the pool power control, which is intended to save power consumption, is unacceptable. Therefore, it is necessary to take some measures even in the situations described above for preventing the pool power control from affecting the application.

Therefore, in this embodiment, the pool 202 implemented by the distributed RAID is partitioned into cycles 400 each having a fixed length, as described with reference to FIGS. 2 to 4B, and, when the power saving mode 801 transitions to the burst mode 800, only a cycle 400 storing therein a small amount of data is selected, and the pool 202 is partially extended only to the selected cycle 400, and not to the other cycles 400. In this manner, the amount of data to be moved in the transition to the burst mode 800 is reduced. Note that, with the parcel mapping 205, the cycles are mapped between the pool 202, the virtual parity group 200, and the distributed parity group 201.

The configuration example of the storage device illustrated in FIG. 1 is also applicable to this embodiment.

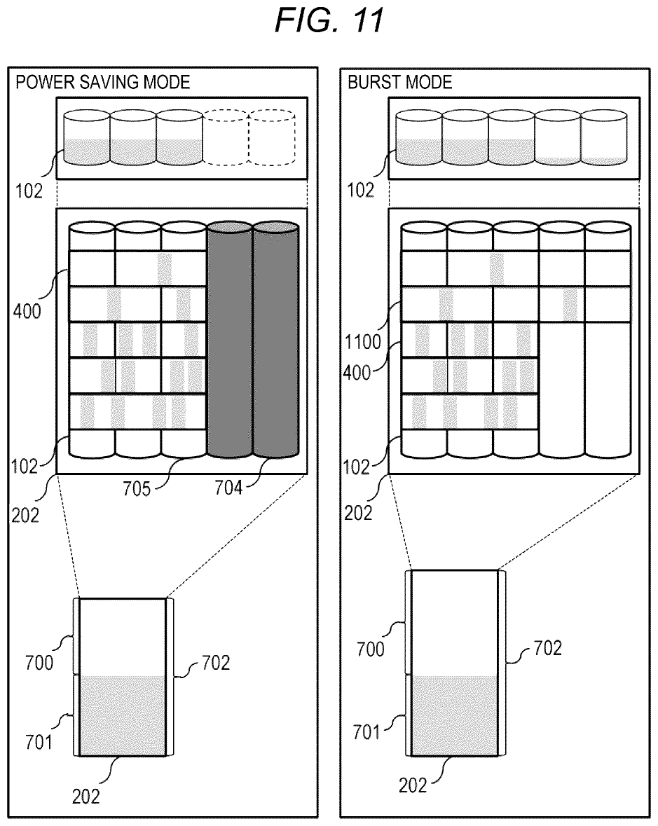

FIG. 11 illustrates an example of the pool power control implemented with the distributed RAID according to this embodiment.

In this embodiment, the pool 202 in the distributed RAID is partitioned into cycles 400 that are areas each having a fixed length. FIG. 11 illustrates, as a method for forming a cycle 400, an example in which the areas of the active drives 102 included in the pool 202 are partitioned into areas of a fixed length, and cycle 400 are formed by collecting the areas evenly from the active drives.

During the power saving mode 801, all of the cycles 400 are shrunk evenly, and some of the drives 102 are in the hibernation state; thus there is no difference with respect to the first embodiment.

When the pool 202 then transitions from the power saving mode 801 to the burst mode 800, all of the drives 102 are resumed. However, unlike in the first embodiment, only the cycles 400 storing therein small amount of data are extended selectively, and only a part of the areas of the resumed drives 102 are made available as the pool capacity. The cycle 400 selectively extended in the burst mode 800 is referred to as a burst cycle 1100. In this manner, the fixed length of the cycle is a size that is maintained unless a drive is added to or deleted from the pool 202 (distributed parity group 201), and is extended or shrunk as a drive is added or deleted.

As a method of selecting a cycle to be extended when the mode is transitioned to the burst mode 800, for example, there is a method of providing the control information area with a table for recording the amount of each piece of data stored in each cycle one by one, and for referring to this table and extending only the cycle in which the amount of stored data is equal to or less than a threshold, as a burst cycle.

As described above, by extending the cycle in which the amount of stored data is equal to or less than the threshold, it is possible to reduce the drive load accrued in moving the data in extending the cycle. In addition, by extending the cycle storing therein data the amount of which is equal to or less than the threshold, the time for moving the data can be reduced, compared with that required in extending the cycle storing therein data the amount of which is greater than the threshold.

Note that, in this embodiment, only the cycle 400 storing therein a small amount of data is selectively extended when the power saving mode 801 transitions to the burst mode 800, but only the cycle 400 storing therein a small amount of data may be selectively extended regardless of the mode of the pool.

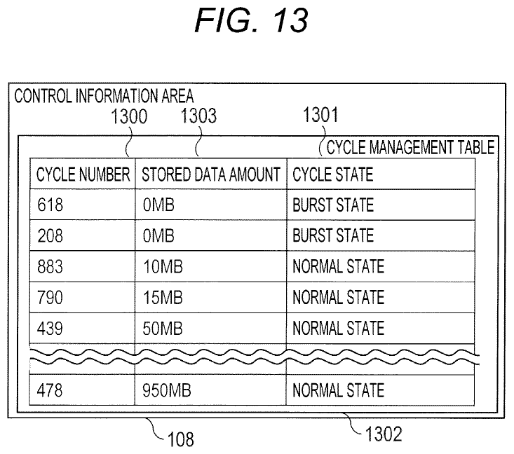

FIG. 13 illustrates a configuration example of a cycle management table according to this embodiment.

This cycle management table 1302 corresponding to each pool in this embodiment has three columns that are the cycle number 1300, a stored data amount 1303, and a cycle state 1301, and is kept sorted in the ascending order of the amount of stored data, for example.

When the pool 202 transitions from the power saving mode 801 to the burst mode 800, the storage device 120 refers to the cycle management table 1302 corresponding to the pool, sequentially selects a cycle at the top and extends the cycle, and stops extending the cycle at the timing when the stored data amount 1303 exceeds the threshold.

The cycle state 1301 of an extended cycle 400 records that the pool is in the burst state when the cycle is extended. When the pool 202 transitions from the burst mode 800 to the power saving mode 801, the storage device 120 refers to this column of the cycle state 1301, and shrinks the cycle 400 having the cycle state 1301 recording the burst state.

In this embodiment, it is assumed that, by selectively extending a cycle 400 with a small amount of stored data, the drive load factor can be reduced in the performance-based pool power control. However, it is also possible to maximize the effect of reducing the drive load during the burst mode by using an additional-write-based data storage logic when data is stored in the pool 202, for example, so that unbalance among the cycles in the amount of data stored is maximized and that the amount of data moved in the transition to the burst mode 800 is reduced.

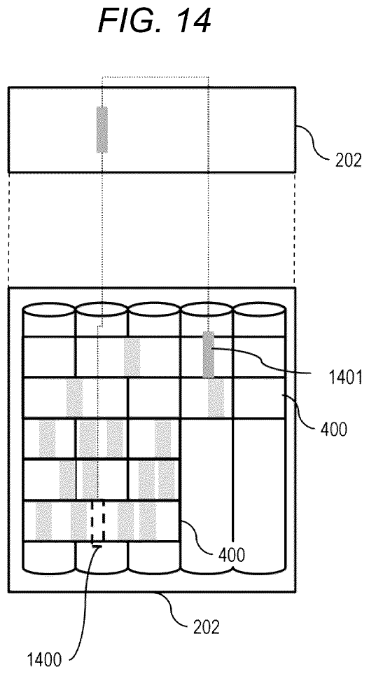

FIG. 14 illustrates an example of additional-write-based data storage logic in this embodiment.

In the example illustrated in FIG. 14, every time when a host device overwrites data 1400 stored in the pool 202, a new storage area is ensured and the overwrite data is stored in the storage area, instead of updating the data 1400 directly. This is called log-structured write.

For example, when a storage area for overwrite data 1401 is to be ensured, the cycle management table 1302 is referred to. If there is any burst cycle 1100, a new area is ensured as large as possible, and the overwrite data 1401 is stored in the area. If there is no burst cycle, the same cycle management table 1302 is referred to again, and the new area is ensured in the cycle 400 storing therein the largest amount of data. In this manner, it is possible to maximize the effect of distributing the drive load during the burst mode 800, while reducing the amount of data to be moved in the transition to the burst mode 800, by maximizing the unbalance of the data among the cycles 400.

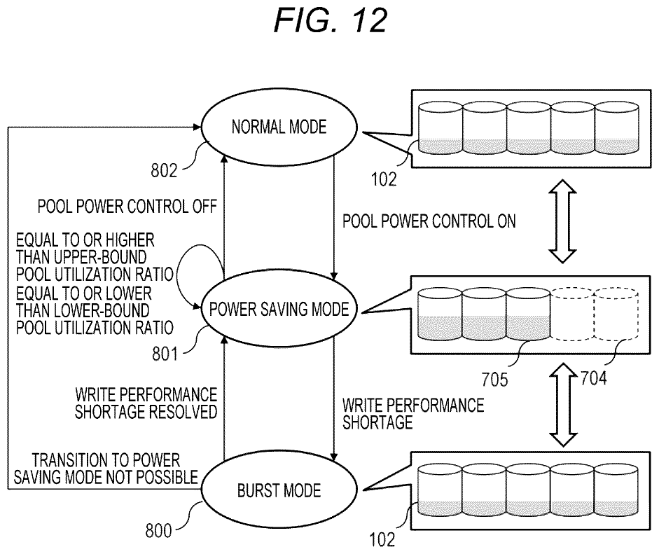

FIG. 12 illustrates an example of a pool state transition according to this embodiment.

The example of the pool state transition according to this embodiment is different from that of the first embodiment in that there is a transition from the burst mode 800 to the normal mode 802.

In the burst mode 800, with the data written to the burst cycle 1100, the amount of data stored in the burst cycle 1100 increases. However, when the amount of data stored in the burst cycle 1100 becomes equal to or greater than a certain value, it may be impossible to shrink the burst cycle 1100 again, and transition to the power saving mode 801 may become impossible.

In such a case, when the burst mode 800 is released, the pool 202 is caused to transition to the normal mode 802, instead of transitioning to the power saving mode, and the pool power control is then disabled.

An example of a processing sequence of each of a drive hibernating process and a drive resuming process in the pool power control according to this embodiment will now be explained.

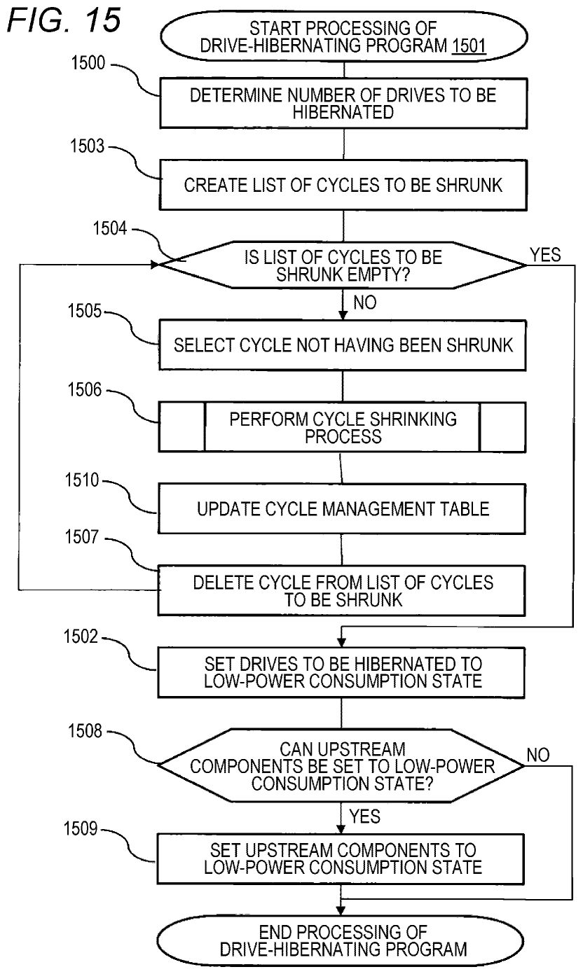

FIG. 15 illustrates a processing sequence of the drive hibernating process according to this embodiment.

A drive-hibernating program 1501 is a program stored in the program area 107, and executed by the CPU 106. In this embodiment, the drive-hibernating program 1501 executes both of a drive hibernating process at the time when the capacity-based pool power control is activated in the normal mode, and a drive hibernating process at the time of transition from the burst mode to the power saving mode.

In step 1500, the drive-hibernating program 1501 determines the number of drives to be hibernated, and creates a list of the drives to be hibernated. When the capacity-based pool power control is applied in the power saving mode, the number of drives to be hibernated is determined only on the basis of the pool utilization ratio. Specifically, the drives to be hibernated are selected in such a manner that the pool utilization ratio after the drive hibernation falls below the target pool utilization ratio, and that the number of drives to be hibernated is maximized.

By contrast, when the burst mode is to be released, it is necessary to hibernate at least all of the drives having been resumed when the mode is transitioned to the burst mode. If, as a result of hibernating all of the drives resumed in the transition to the burst mode, the pool utilization ratio exceeds the upper-bound pool utilization ratio, the capacity-based pool power control may be executed again after the burst mode is released.

In step 1503, the drive-hibernating program 1501 creates a list of the cycles to be shrunk. The cycles to be shrunk herein are, when the capacity-based pool power control is applied in the power saving mode, all of the cycles. By contrast, when the burst mode is to be released, the cycles to be shrunk are cycles having the burst state in the cycle management table 1302.

In step 1504, the drive-hibernating program 1501 determines whether the list of cycles to be shrunk is empty. If the list of cycles to be shrunk is empty, the process goes to step 1507. If the list is not empty, the process goes to step 1505.

In step 1505, the drive-hibernating program 1501 selects one cycle from the list of cycles to be shrunk. For example, the cycle storing therein the smallest amount data may be selected from the list of cycles to be shrunk.

In step 1506, the drive-hibernating program 1501 executes the process of shrinking the cycle selected in step 1505. The process of shrinking the cycle herein involves reallocation of data within the cycle.

In step 1510, when the cycle to be shrunk is a burst cycle, the drive-hibernating program 1501 releases the burst state of the cycle in the cycle management table 1302.

In step 1507, the drive-hibernating program 1501 deletes the cycle shrunk in step 1506, from the list of the cycles to be shrunk, and goes back to step 1504.

In step 1502, the drive-hibernating program 1501 sets all of the drives in the list of drives to be hibernated, created in step 1500, to the low-power consumption state.

In step 1508, the drive-hibernating program 1501 determines whether the upstream components supplying power to the drive having been transitioned to the low-power consumption state in step 1502 can be transitioned to the low-power consumption state. If the transition is possible, the process goes to step 1509. If the transition is not possible, the process of the drive-hibernating program 1501 is ended.

The upstream component can transition to the low-power consumption state when accesses to the active drives other than the hibernated drive are not affected. For example, if all of the drives 102 connected downstream of the drive box 119, the back-end switch 100, or the back-end port 112, which are upstream components, are in the low-power consumption state, such drive box 119, back-end switch 100, and the back-end port 112 can also transition to the low-power consumption state.

In step 1509, the drive-hibernating program 1501 causes the upstream components determined as being possible to be transitioned to the low-power consumption state in step 1508, to the low-power consumption state.

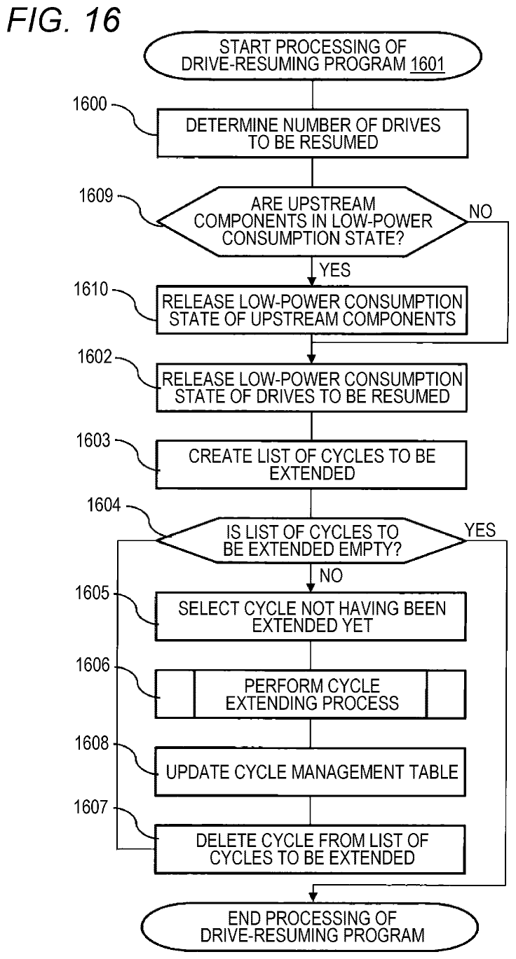

FIG. 16 illustrates a processing sequence of a drive resuming process according to this embodiment.

A drive-resuming program 1601 is a program stored in the program area 107, and executed by the CPU 106. In this embodiment, the drive-resuming program 1601 executes both of a drive resuming process at the time when the capacity-based pool power control is activated during the power saving mode, and a drive resuming process at the time of transition from the power saving mode 801 to the burst mode 800.

In step 1600, the drive-resuming program 1601 determines the number of drives to be resumed, and creates a list of drives to be resumed. When the capacity-based pool power control is activated during the power saving mode, the drives to be resumed is determined in such a manner that the pool utilization ratio is brought to the range of the target pool utilization ratio, as closely as possible. At the time of transitioning from the power saving mode 801 to the burst mode 800, all of the drives 704 in the hibernation state forming the pool are resumed.

In step 1609, the drive-resuming program 1601 determines whether the upstream components supplying power to the drives in the list of the drives to be resumed, the list of which is created in step 1600, are in the low-power consumption state. If the upstream components are in the low-power consumption state, the process goes to step 1610. If the upstream components are not in the low-power consumption state, the process goes to step 1602.

In step 1610, the drive-resuming program 1601 releases the low-power consumption state for the upstream component determined to be in the low-power consumption state in step 1609.

In step 1602, the drive-resuming program 1601 releases the low-power consumption state of all of the drives included in the list of target drives to be resumed, the list of which has been created in step 1600.

In step 1603, the drive-resuming program 1601 determines the number of cycles to be extended, and creates a list of cycles to be extended. In the case in which the capacity-based pool power control is activated during the power saving mode, all of the cycles in the pool are to be extended. In the case of the transition from the power saving mode 801 to the burst mode 800, all of the cycles each storing therein data the amount of which is equal to or less than the threshold are to be extended.

In step 1604, the drive-resuming program 1601 determines whether the list of cycles to be extended is empty. If the list of cycles to be extended is empty, the processing of the drive-resuming program 1601 is ended. If the list is not empty, the process goes to step 1605.

In step 1605, the drive-resuming program 1601 selects one cycle from the list of cycles to be extended. As a criterion for selecting the cycle, the cycle having the smallest amount of stored data may be selected from the list of cycles to be extended.

In step 1606, the drive-resuming program 1601 extends the cycle selected in step 1605. The process of extending the cycle herein involves data reallocation within the cycle.

In step 1608, in the case of the transition from the power saving mode 801 to the burst mode 800, the drive-resuming program 1601 updates the cycle management table corresponding to the cycle extended in step 1606, to set the cycle to the burst state.

In step 1607, the drive-resuming program 1601 deletes the cycle extended in step 1606 from the list of cycles to be extended, and goes back to step 1604.

### Third Embodiment

The pool power control described in the first embodiment may also be applied to a pool implemented using a system other than the distributed RAID. In this embodiment, as an example of such a system, a pool power control system based on a conventional RAID system, in which a pool is formed by parity groups, will be described. The description pertinent to the addition and the deletion of a physical drive in the first embodiment but not mentioned in this embodiment are applicable to this embodiment, with the physical drive replaced with the parity group.

The same configuration example of the storage device illustrated in FIG. 1 is also applicable to this embodiment.

In this embodiment, the data protection based on a conventional RAID system is applied to the data stored in the drives 102, and power consumption is reduced on the basis of the pool power control.

In the conventional RAID system, a parity group 1700 is formed by combining m data drives 1701 storing therein data and n parity drives 1702 storing therein redundancy codes (parities) for the data stored in the data drives 1701.

A pool 202 in the conventional RAID system includes one or more parity groups 1700. In the conventional RAID system, the parity group 1700 is the minimum unit in which the pool capacity is managed, and the capacity of the pool 202 is changed only by adding a parity group 1700 to the pool 202 or excluding a parity group 1700 from the pool 202.

In the conventional RAID system, redundancy by RAID is achieved by combining a data drive 1701 and a parity drive 1702 in the parity group 1700. For example, the parity group 1700 including a total of three drives including two data drives 1701 and one parity drive 1702 has redundancy of 2D1P. The scheme for ensuring the redundancy with the RAID is not limited in this embodiment, but redundancy using RAID5 or RAID6 may be used, for example.

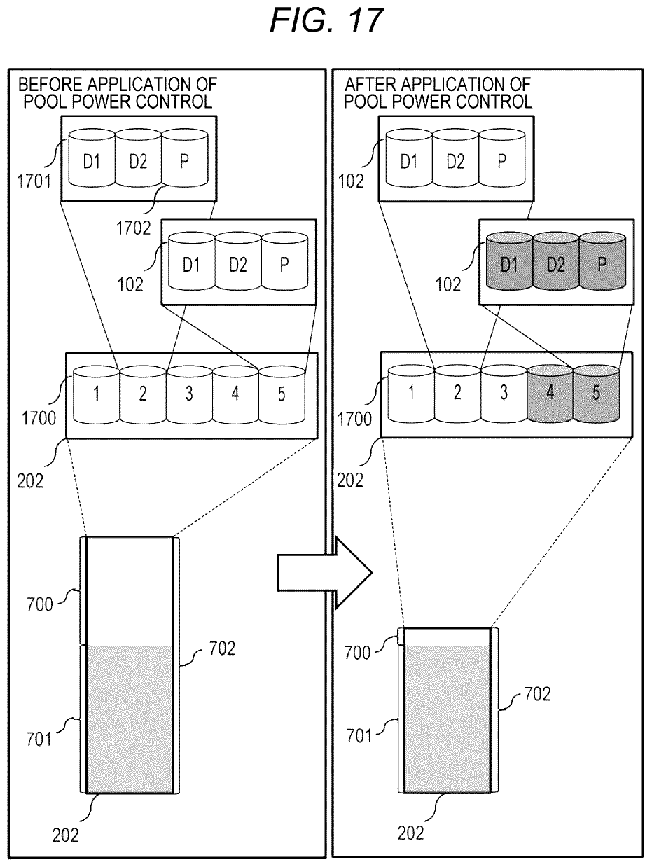

FIG. 17 illustrates an example of the pool power control implemented with a conventional RAID in this embodiment.

For example, FIG. 17 illustrates an example in which the pool power control is applied to a pool including five parity groups of 2D1P, and two of these parity groups are to be hibernated.

Hibernating the parity group 1700 herein refers to an operation of deleting the parity group 1700 from the pool 202, and causing all the drives 102 included in the parity group 1700 to transition to the low-power consumption state. Resuming a parity group 1700 refers to an operation of releasing the low-power consumption state of all of the drives 102 in the parity group 1700, and adding the parity group to a pool.

Hereinafter, a parity group having been hibernated will be referred to as a parity group in the hibernation state, and a parity group not having been hibernated or having been resumed is referred to as a parity group in the active state.

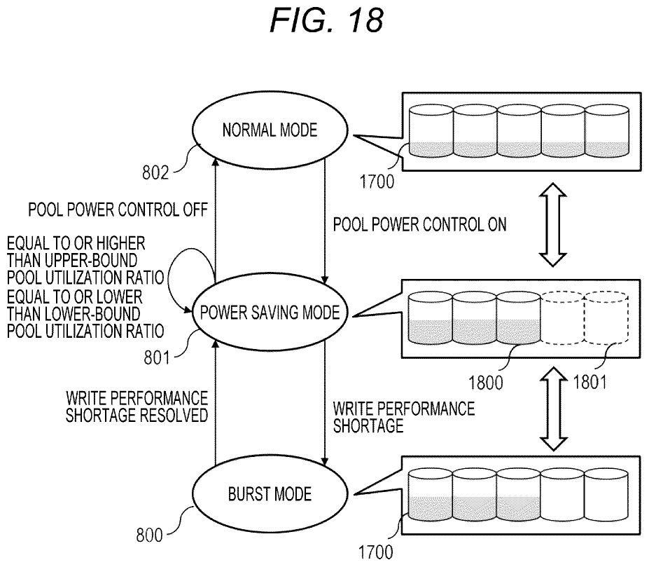

FIG. 18 illustrates an example of a pool state transition in this embodiment.

The pool 202 according to this embodiment has three modes of the normal mode 802, the power saving mode 801, and the burst mode 800, in the same manner as in the first and the second embodiments.

The normal mode 802 is a mode in which all of the parity groups 1700 are in the active state.

The power saving mode 801 is a mode in which a part of the parity groups 1700 is in the hibernation state.

The burst mode 800 is a mode in which all of the parity groups 1700 are in the active state. A difference between the normal mode 802 and the burst mode 800 is in whether the amount of stored data is equalized among the parity groups 1700.

In the conventional RAID, a rebalancing process for rebalancing the amount of stored data among the parity groups 1700 included in a pool 202 is sometimes implemented. By contrast, a resumed parity group immediately after being resumed in the burst mode is empty, and there is a difference between the amounts of data stored in the resumed parity group and in a parity group having been originally in the active state. Therefore, the data is moved from the latter parity group to the former parity group to equalize the amounts of data stored in the parity groups. However, if the drive load factor increases due to this movement of data, the effect of suppressing the drive load factor, which is achieved by the burst mode 800, deteriorates.

Therefore, in this embodiment, it is assumed that the rebalancing processing between the parity groups 1700 included in a pool is stopped while the pool is in the burst mode 800.

The triggers for the transition between the normal mode, the power saving mode, and the burst mode are the same as those in the first and second embodiments.

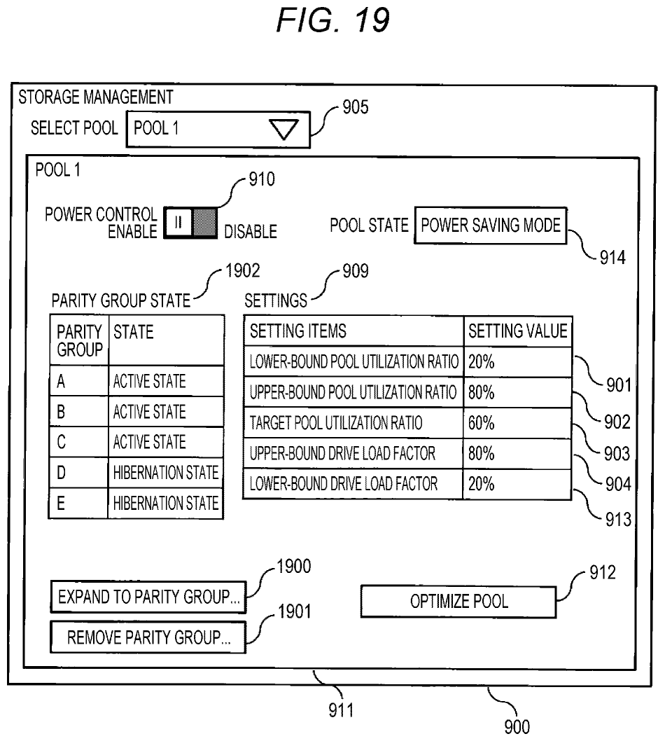

FIG. 19 illustrates a configuration example of a pool power control setting screen according to this embodiment.

When the user 118 selects one of the pools 202 in the storage device 120 from the pool list 905, the display 900 provided on the management device displays the setting screen 911 for the pool 202.

The setting screen 911 for each pool 202 includes the switch 910 for enabling or disabling the pool power control for the pool, the indicator 914 for displaying the state of the pool, the parity group state table 1902 for displaying the states of the respective parity groups 1700 included in the pool, and the power control parameter table 909 for setting the pool power control parameters for the pool.

As to a function for selecting the parity group 1700 to be included in the pool 202, there is no particular limitation in this embodiment. It is assumed herein that there is an interface for allowing the user 118 to select a parity group 1700 to be included in the pool 202, from the parity groups 1700 set in the storage device 120. For example, the pool setting screen 911 may include a button 1900 for expanding the pool to a parity group 1700, and a button 1901 for removing a parity group 1700.

The parity group state table 1902 displays whether each parity group 1700 forming the pool 202 is in an active state or in a hibernation state.

The power control parameter table 909 is enabled to be specified with at least four parameters including a lower-bound pool utilization ratio 901, an upper-bound pool utilization ratio 902, a target pool utilization ratio 903, an upper-bound drive load factor 904, and a lower-bound drive load factor 913.

Note that a scalar value may be set to the upper boundary and the lower boundary, and a range, e.g., 40% to 60%, may be set to the target.

The pool setting screen 911 may also include a pool optimization button 912.

The power control switch 910 controls the transition between the normal mode 802 and the power saving mode 801. In other words, transition of the pool from the normal mode 802 to the power saving mode 801 is triggered by the power control switch 910 being switched from OFF to ON, and transition of the pool from the power saving mode 801 to the normal mode 802 is triggered by the power control switch 910 being switched from ON to OFF.

In the capacity-based pool power control, a trigger for hibernating a parity group 1700 and a trigger for resuming the parity group 1700 are determined by referring to the settings of the management device 116.

For example, by being triggered by the pool utilization exceeding the upper-bound pool utilization ratio 902; the pool optimization button 912 being pressed by a user; or the pool power control switch 910 being switched from ON to OFF by a user operation, the storage device 120 determines the number of parity groups to be resumed, if there is any parity group 1801 in the hibernation state, in such a manner that the pool utilization ratio falls within the range of the target pool utilization ratio 903, and resumes the parity groups.

By contrast, by being triggered by the pool utilization falling below the lower-bound pool utilization ratio 901; the pool optimization button 912 being pressed by the user; or the pool power control switch 910 being switched from OFF to ON by a user operation, the storage device 120 determines the number of parity groups to be hibernated in such a manner that the pool utilization ratio falls within the target pool utilization ratio 903, hibernates the parity groups, and causes the pool to transition to the power saving mode 801.

Note that depending on the number of parity groups included in the pool and the states of the parity groups, it may be impossible to hibernate or to activate a parity group in such a manner that the pool utilization ratio falls within the target pool utilization ratio 903. In such a case, an error message may be presented to the user.

In the performance-based pool power control, a trigger for hibernating a parity group 1700 and a trigger for resuming the parity group 1700 are determined by referring to an indication value of the performance monitor 117, as well as the settings of the management device 116.

For example, the storage device 120 monitors the load factor of the drives 102 using the performance monitor 117, and by being triggered by the load factor of the drives in the pool 202 exceeding the upper-bound drive load factor 904, the storage device 120 resumes all of the parity groups 1801 in the hibernation state, if there is any parity group 1801 in the hibernation state in the pool, and causes the pool to transition to the burst mode 800.

However, in situations such that the load factor of the CPU 106 is high, or the load factor of the front-end port connecting the host device and the storage device is high, it is possible that the performance shortage is not resolved even by activating the drives when the load factor of the drive 102 has exceeded the upper-bound drive load factor 904. The storage device 120 may therefore be implemented to monitor the load factor of the components other than the drives, as well as the load factor of the drives, using the performance monitor 117, and negates to resume the drives if it is determined that, although the load of the drives in the pool is high, the performance shortage is not improved by resuming the drives, because the load of another predetermined component is higher than a predetermined reference value.

Furthermore, the load factor of a drive is a parameter that changes greatly over time, that usually remains low but surges instantaneously. Hence, the performance monitor 117 may be configured to present an average of the load factors of the respective drives over a certain time period so that the pool power control is not released even when the load surges instantaneously, for example. Note that the descriptions in the first embodiment pertinent to the drive load factor that is a value representing the drive load of a pool, and the load factor that is a value representing the load of a predetermined component other than a drive (e.g., a CPU or a front-end port) are also applicable in this embodiment.

The storage device 120 monitors the load factor of the drives 102 using the performance monitor 117. By being triggered by the drive load factor falling below the lower-bound drive load factor 913, the storage device 120 determines the number of parity groups to be hibernated on the basis of the target pool utilization ratio 903, hibernates the parity groups, and causes the pool to transition to the power saving mode 801.

As parity groups to be hibernated, the storage device 120 selects a combination of parity groups hibernation of which results in a pool utilization ratio below the target pool utilization ratio 903, and minimizes the total number of drives included in the parity groups to be hibernated.

Note that the present invention is not limited to the embodiments described above, and includes various modifications thereof. For example, because the embodiment has been explained above in detail to facilitate understanding of the present invention, the present invention is not necessarily limited to the configuration including all of the elements explained above. Furthermore, a part of the configuration according to one embodiment can be replaced with a configuration according to another embodiment, and a configuration according to another embodiment may be added to the configuration of the one embodiment. In addition, another configuration may be added to, deleted from, and replaced with a part of the configuration according to each of the embodiments.

In addition, some or all of the configurations, functions, and the like explained above may be implemented as hardware, through designing of an integrated circuit, for example. In addition, each of the configurations, the functions, and the like described above may be implemented as software by causing a processor to parse and to execute a program that implements the function. Information such as a computer program, a table, and a file for implementing each of the functions may be stored in a recording device such as a memory, a hard disk, and an SSD, or a recording medium such as an IC card, and an SD card.

In addition, control lines and information lines presented are those considered to be necessary for the explanation, and are not necessarily the representations of all of the control lines and the information lines in the product. In reality, it is possible to consider that almost all of the configurations are connected to one another.

What is claimed is:

1. A storage system comprising:
a plurality of physical drives that physically store data; and
a storage controller that controls an access to the plurality of physical drives, wherein
the plurality of physical drives form a distributed parity group,
the storage controller is configured to provide storage areas of the plurality of physical drives forming the distributed parity group to a host device as a pool that is a virtual storage area,
the pool includes one or more virtual parity groups including a plurality of virtual drives,
number of the plurality of virtual drives forming the virtual parity group is equal to or smaller than number of physical drives forming the distributed parity group,
each of the plurality of physical drives has
a first state in which an input or an output of data is enabled; and
a second state in which an input and an output of data are disabled, and less power is consumed than power consumed in the first state, and
the storage controller is configured to:
cause one or more physical drives having been deleted from the pool to transition from the first state to the second state; and
add the one or more physical drives to the pool after causing the one or more physical drives in the second state to transition to the first state.

2. The storage system according to claim 1, wherein
the distributed parity group is partitioned to cycles, and
the storage controller is configured to:
perform a cycle extension in which a storage area of a physical drive transitioned from the second state to the first state is added to the distributed parity group as a capacity of the pool, and
perform the cycle extension on a cycle storing an amount of data equal to or less than a threshold.

3. The storage system according to claim 2, wherein
a mode of the pool includes a normal mode, a power saving mode, and a burst mode,
the normal mode is a state in which pool power control is disabled, and all of the plurality of physical drives are in the first state,
the power saving mode is a state in which the pool power control is enabled and a part of the plurality of physical drives is in the second state,
the burst mode is a state in which the pool power control is enabled, and the physical drives having been in the second state are temporarily put into the first state and resumed to the pool,
the storage controller is configured to:
cause the pool to transition to the power saving mode by being triggered by the pool being in the normal mode, and by the pool power control becoming enabled,
cause the pool to transition to the normal mode by being triggered by the pool in the power saving mode, and the pool power control becoming disabled;
cause the pool to transition to the burst mode by being triggered by the pool being in the power saving mode; a value representing a drive load of the pool exceeding a threshold; and a value representing a load of a predetermined component of a type different from the physical drive falling below a threshold, and
cause the pool to transition to the power saving mode by being triggered by the pool being in the burst mode; and the value representing the drive load of the pool falling below a threshold, and
the storage controller is also configured to:
execute the cycle extension in the power saving mode, and to cause the pool to transition to the burst mode, by being triggered by the pool is in the power saving mode; the value representing the drive load of the pool exceeding a threshold; and the value representing the load of the predetermined component falling below the threshold; and
delete the added physical drive from the pool, and cause the pool to transition to the power saving mode, by being triggered by the pool being in the burst mode; and by the value representing the drive load of the pool falling below the threshold.

4. The storage system according to claim 1, wherein
the storage controller is configured to:
identify a component a type of which is different from a physical drive and that is capable of being transitioned from a normal state to a low-power consumption state by causing the one or more physical drives to transition to the second state, and
cause the component to transition to the low-power consumption state, as the one or more physical drives transition to the second state.

5. The storage system according to claim 1, wherein
the storage controller is configured to:
select a physical drive to be deleted from the pool so as to bring a vacant capacity of the pool within a preset range; and
select a physical drive to be added to the pool from one or more physical drives in the second state so as to bring the vacant capacity of the pool within the preset range.

6. The storage system according to claim 5, wherein
a trigger for selecting a physical drive to be deleted from the pool includes at least one of a user instruction and the value representing the vacant capacity of the pool exceeding the threshold, and
a trigger for selecting a physical drive to be added to the pool includes at least one of a user instruction or the value indicating the vacant pool capacity falling below the threshold.

7. The storage system according to claim 1, wherein
the storage controller is configured to:
delete a physical drive from the pool by being triggered by a value representing a drive load of the pool falling below a threshold; and
add a physical drive to the pool by being triggered by the value representing the drive load of the pool exceeding a threshold.

8. The storage system according to claim 1, wherein
the storage controller denies adding a physical drive when a value representing a load of a predetermined component of a type different from the physical drive exceeds a threshold.

9. The storage system according to claim 1, wherein
a mode of the pool includes a normal mode, a power saving mode, and a burst mode,
the normal mode is a state in which pool power control is disabled, and all of the plurality of physical drives are in the first state,
the power saving mode is a state in which the pool power control is enabled and a part of the plurality of physical drives is in the second state,
the burst mode is a state in which the pool power control is enabled, and a physical drive having been in the second state is temporarily put into the first state and resumed to the pool,
the storage controller is configured to:
cause the pool to transition to the power saving mode by being triggered by the pool being in the normal mode and the pool power control becoming enabled,
cause the pool to transition to the normal mode by being triggered by the pool being in the power saving mode and the pool power control becoming disabled;
cause the pool to transition to the burst mode by being triggered by the pool being in the power saving mode; a value representing a drive load of the pool exceeding a threshold; and a value representing a load of a predetermined component of a type different from the physical drive falling below a threshold, and
cause the pool to transition to the power saving mode by being triggered by the pool being in the burst mode; and the value representing the drive load of the pool falling below a threshold.

10. The storage system according to claim 9, wherein,
while the pool is in the burst mode, the storage controller is configured to stop rebalancing for equalizing amounts of data stored in parity groups included in the pool.

11. A storage system comprising:
a plurality of physical drives; and
a storage controller that controls an access to the plurality of physical drives, wherein
the plurality of physical drives form a plurality of parity groups,
the storage controller is configured to provide a storage area of the plurality of parity groups to a host device as a pool that is a virtual storage area, and
each of the plurality of physical drives has
a first state in which an input or an output of data is enabled; and
a second state in which an input and an output of data are disabled, and less power is consumed than power consumed in the first state, and
the storage controller is configured to:
cause a first parity group deleted from the pool to transition from the first state to the second state;
identify a component a type of which is different from a physical drive and that is capable of being transitioned from a normal state to a low-power consumption state by causing the first parity group to transition to the second state and cause the component to transition to the low-power consumption state; and
add the first parity group to the pool after causing the first parity group to transition from the second state to the first state and cause the component to transition to the normal state.

12. The storage system according to claim 11, wherein
the storage controller is configured to:
select a parity group to be deleted from the pool so as to bring a vacant capacity of the pool within a preset range; and
select a parity group to be added to the pool from one or more parity groups in the second state so as to bring the vacant capacity of the pool within the preset range.

13. The storage system according to claim 12, wherein
a trigger for selecting a parity group to be deleted from the pool includes at least one of a user instruction and the value representing a vacant capacity of the pool exceeding the threshold, and
a trigger for selecting a parity group to be added to the pool includes at least one of a user instruction or the value indicating the vacant capacity of the pool falling below the threshold.

14. The storage system according to claim 11, wherein
the storage controller is configured to:
delete a parity group from the pool by being triggered by a value representing a drive load of the pool falling below a threshold; and
add a parity group to the pool by being triggered by the value representing the drive load of the pool exceeding a threshold.

15. The storage system according to claim 11,
wherein the storage controller denies adding a parity group when a value representing a load of a predetermined component of a type different from the physical drive exceeds a threshold.
